(19) United States
(12) Patent Application Publication
(10) Pub. No.: US 2002/0070921 A1
(43) Pub. Date: Jun. 13, 2002

(54) Holographic keyboard

(76) Inventor: Stephen E. Feldman, New York, NY (US)

Correspondence Address: STEPHEN E. FELDMAN, P.C., 12 East 41st Street, New York, NY, 10017, US

(21) Appl. No.: 09/734,874

(22) Filed: Dec. 13, 2000

(51) Int. Cl. G09G 5/00

(52) U.S. Cl. 345/168

(57) ABSTRACT

The present invention is directed to a holographic keyboard. The present invention comprises a portable unit that further comprises a hologram producing means, sensory reception means, and signal processing means. The hologram producing means create an image of a keyboard with all of its keys mapped out. The sensory reception means is an array of sensory elements, preferably, photodiodes capable of receiving and detecting changes in a light pattern, which are arranged so that each sensory element corresponds to a projected key on the holographic image of the keyboard. Due to such an arrangement each sensory element is inclined in a certain way. The signal processing means receive a signal after a sensory element has been interrupted and process such signal. The invention allows its user to easily carry it around.

### FIELD OF INVENTION

The present invention relates to a holographic sensory perception device. In particular, the present invention is directed to a holographic keyboard. The present invention comprises an apparatus that generates a holographic projection of a computer or any other keyboard, an array of sensor receptors, arranged in matrix, wherein each sensor receptor corresponds to a key on a projected image of the keyboard. Furthermore, the sensor receptors may be ambient light sensor receptors capable of detecting changes in light density.

### BACKGROUND OF THE INVENTION

There are several known apparatuses for holographic projections capable of producing different images designated by the image producing mechanism. Furthermore, there are many different kinds of sensors that are conventionally well known. However, a combination of above elements has not been addressed and, thus, a need for a sufficiently small device (such as the one capable of fitting in a pocket) has not been fulfilled by the current prior art. There is a long felt need to create a portable device that is capable of being easily carried around while capable of producing high-quality images, and such device would serve a purpose of reception and transmission of information to appropriate sources for further processing.

The invention would be better understood if theoretical concepts would be explained in some detail. A hologram is a medium containing information and is nothing more than a high contrast, very fine grain, black and white photographic film. There are several different types of holograms and discussion of each type will be separately addressed below.

The first type is a transmission hologram. In order to playback a hologram, the hologram's reference beam must be shone back through the hologram at the same angle relationship as it had in construction. This is where the term transmission hologram arises. Transmission merely means that the reference beam must be transmitted through the hologram in order for the image to be reconstructed. A part of the original beam goes through a glass and a part is reflected at the same angle as its incident. This allows one to bring in the reference beam from an infinite number of angles in relation to the object directed beam, thus, avoiding an inconvenience in playback of having to look directly in the reference beam as with the in-line, transmission hologram.

A transmission type hologram means that the reference beam must be transmitted through the hologram, in order to decode the interference patterns and render the reconstructed image. The light which is used for playback must be coherent or semi-coherent or the image will not be sharp. If a non-coherent source, such as a light from a common, unfiltered slide projector is used, then the hologram will diffract different wavelengths. The interference pattern or grating etched in the emulsion is not particular as to which wavelengths it bends or focuses; therefore, an unclear overlapping spectrum of colors resembling the object is produced.

A hologram will playback just as well with laser light of a different color or wavelength than the light with which it was made. However, the object will appear to be of a different size and/or distance from the plate. For example, a hologram of an object made with neon or red light will playback that object smaller or seemingly further away if a blue color laser is used. This is because the grating will bend the blue or shorter light less severely than the red with which it was made and with which it is meant to be decoded.

Another type of a hologram is plane or volume hologram. In a plane transmission hologram, the reference beam is hitting the film from the same side as the object beam. In a volume reflection hologram, the reference beam makes an arc clear around so that it hits the film from the opposite side as the modulated object beam.

The hologram can be viewed in white light or light which contains many different wavelengths. The one requisite is that the light be from a point source and be a somewhat straight line, such as a slide projector light or penlight, or the sun on a clear day. The reflection hologram can do this because in a way it acts as its own filter. In a reflection hologram the fringes are packed so closely together that they constitute layers throughout the thickness of the emulsion. The spacing between fringes remains constant. If a distance between a first fringe and a second fringe is two microns, for example, then the distance between the remaining layers of fringes will also be two microns. This distance is a function of the wavelength of light used in constructing the hologram and also the angle difference between reference and object beams. This layered affair allows the reflection hologram to absorb, or not reflect, any of the colors or wavelengths of light which are not the correct length. The wavelength which matches the fringe spacing will be reflected: the crests of the wavelengths which are too short or too long will eventually miss one of the planes and be absorbed into the darkness of the emulsion. In a reflection type hologram, the playback light or reconstruction beam comes from the same side of the hologram as the viewer. Some parts of the incident light are reflected, some are not, depending on the interference pattern. If the hologram was made correctly the result should be a visible three-dimensional image. In the transmission type hologram, the reconstruction beam must pass through the hologram and come towards the viewer from the opposite side of the hologram while in the reflection type the playback source comes from the same side of the hologram as the viewer.

Another type of a hologram is a multiplex hologram. This type of a hologram has a more common usages in today's technology. The multiplex hologram is the holographic storage of a photographic information. In the first stage a series of photographs or a certain amount of motion picture footage of the subject is exposed. The number of stills or frames taken depends on how much of an angle of view of the subject is desired in the finished hologram. For example, if a 360-degree view of the subject, exposure of three frames per degree of movement around the subject is recommended (usually the camera remains stationary and the subject rotates) this will result in the exposure of 1080 frames. The film must be developed and using a laser a series of “slit” holograms using each frame of film as a subject for each slit of holographic film must be made. The slits are usually about one millimeter wide and are packed so closely that there is no “dead space” in between. Also, the hologram is bleached so that the strips disappear. Usually a multiplex hologram yields a horizontal not a vertical parallax. This is because the camera usually moves around (or the subject moves around in front of the camera) and doesn't usually pass over the subject. Also, psychologically, horizontal parallax is much more desirable and the lack of horizontal parallax is much more noticeable than the lack of vertical parallax. The multiplex hologram is usually, though not always, made on flexible film coated with the same holographic emulsion as the plates. The procedure can be totally mechanical so that a machine can expose a slit hologram per each frame of footage at a very rapid pace. The advantage of this type of hologram is that it is possible to have a hologram of almost anything captured on an ordinary film without a need of an expensive, clumsy procedure. The disadvantage is that it is not truly a hologram but a photographic information holographically stored.

There are several U.S. patents available, however, none of them fulfill the particular need that the present invention addresses.

U.S. Pat. No. 6,031,519 to O'Brien teaches a holographic direct manipulation interface comprising an apparatus for displaying a hologram, detection sensors of any movement relative to the hologram and a processing means for covering a location of a detected object directly relative to its position on the displayed hologram into an output signal. The present invention comprises of an array of sensory receptors capable of detection of intercepted light and sending a signal to a processing unit to inform the processing unit of such interception. Furthermore, the present invention comprises a hologram producing mechanism capable of creating a hologram depicting a keyboard. Each sensory element is positioned so that its detection point is located on a projection of a key of the holographic keyboard to which such sensor element corresponds. Upon touching of such holographic key, a user with her finger intercepts an access of light to corresponding sensory element, thereby activating such sensory element and, thus, communicating a signal to a processing unit. The present invention provides for an accurate reception of signals, since, both the sensor elements and the keys on the keyboard are so distributed that there is no interruption between signals. Finally, the present invention fulfills a need of a lightweight and portable apparatus that is capable of performing the above-described functions.

### SUMMARY OF THE INVENTION

The present invention is directed to an apparatus that is capable of receiving and transmitting signals upon activation of an element located on a holographic projection of an image.

Another object of the present invention is to create a holographic keyboard having a holographic projection of a keyboard and an array of light-sensing elements, wherein keys on such holographic keyboard correspond to light sensing elements in the array and wherein such light sensing elements are capable of detecting an interruption of a flow of ambient light.

Another object of the present invention is to create small portable device capable of creating a holographic image of a keyboard and having an ambient light sensing element means corresponding to keys on the image of such keyboard.

### BRIEF DESCRIPTION OF THE DRAWINGS

The following description of the drawings is only for the purposes of illustration and better understanding of the present invention. The drawings depict a preferred embodiment, which is understood by one skilled in the art as not limiting the present invention, but only to illustrate the concepts and ideas involved. The present invention is limited only by the existing prior art and the disclosure and claims communicated below.

FIG. 1 is a perspective view of a preferred embodiment of the present invention showing a projection of a keyboard and an array of ambient light sensing elements.

FIG. 2 is a plain view of the preferred embodiment the present invention's array of ambient light sensing elements.

FIG. 3 is a perspective view of the preferred embodiment the present invention's holographic projection mechanism.

FIG. 4 is a schematic view of the present invention's use.

### DETAILED DESCRIPTION OF THE INVENTION

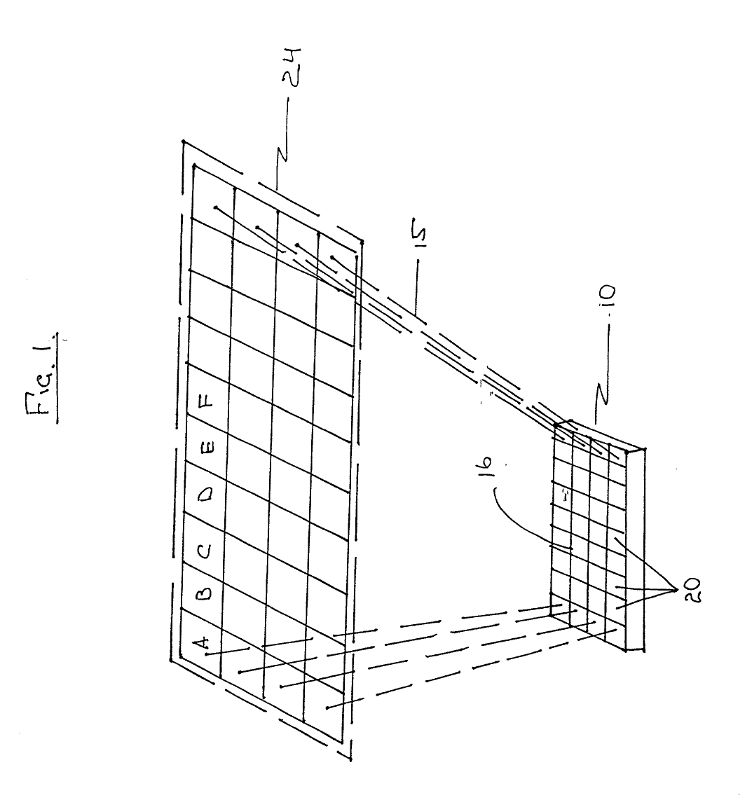

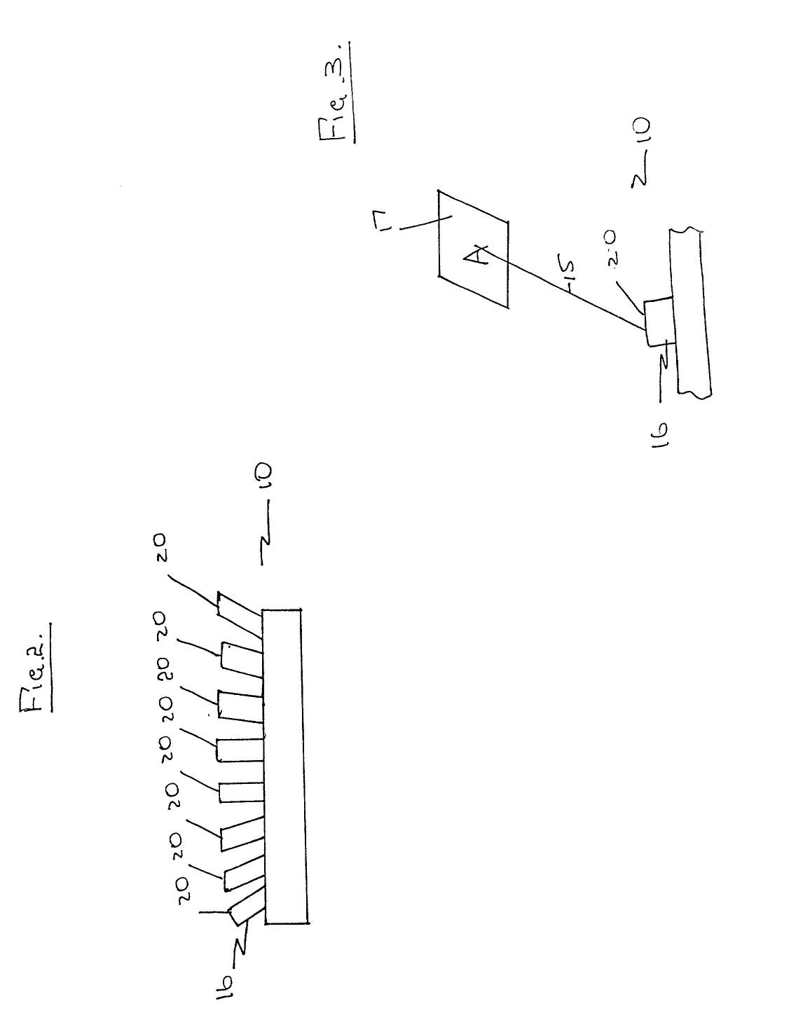

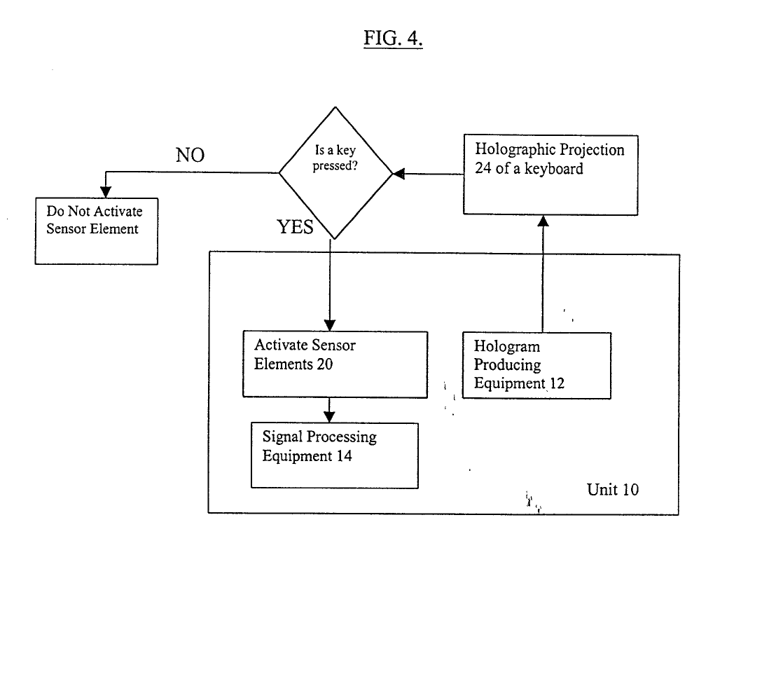

Referring FIGS. 1 through 4, the present invention is shown to have a unit 10, which encompasses in itself a hologram producing equipment 12, a signal processing equipment 14 and a sensory elements array 16.

Referring to FIGS. 1 through 3, the array 16 comprises of a plurality of sensory elements 20. Each element 20 is positioned at a certain angle so that it corresponds to a position on a holographic projection 24 of a keyboard. In this particular embodiment, elements 20 are photodiodes capable of detection of interception of access of light to the elements 20. Therefore, when light path 15 of a particular element 20 is intercepted by user, the element 20 acknowledges such interception and sends a signal to the signal processing equipment 14. After such interception of the light path 15, the element 20 resets itself, so that it is capable of detection of subsequent interceptions of light path 15. In another embodiment, the elements 20 are ambient light photodiodes capable of sensing interception of access of light to the sensor element.

The hologram producing equipment 12 is capable of projecting an image of a keyboard 24 within a relatively small distance away from the unit 10. The hologram image of the keyboard 24 may be a flat hologram, as opposed to a volume hologram. The hologram image is viewed from the top and appears as a regular keyboard with keys 17 mapped out as in any conventionally known keyboard. To the user the image appears as a flat surface with squares as keys 17, which the user may touch, thereby intercepting the access of light to the sensor elements 20. The user does not have to hit the virtual keyboard, but only put her fingers through the image without touching the sensor elements 20. When the user puts her fingers through one key 17 of the virtual keyboard, the sensor element 20 detects such action, since the light path 15 has been intercepted. Then the sensor element 20 sends a signal to the signal processing unit 14.

Referring to FIGS. 1 through 4, the sensing element array 16 is shown to have a plurality of sensor elements 20. The inclination of each sensor element 20 is dependent on a position of each key 17 on the holographic projection of the keyboard produced by the hologram producing unit. The array is so manufactured as to have the sensor elements being capable of receiving separate signals from a separate key 17 of the keyboard. Furthermore, the sensor elements are so tuned up that if a user accidentally does not hit a center of a key, but hits the keyboard in between the key no sensor element in the sensing element array 16 will be activated. This means that if light paths of multiple elements are intercepted at the same time, then the sensor elements send multiple signals to the signal processing unit and, therefore, the signal processing unit does not produce an output, as opposed to a case, when a single key is hit and a single light path is intercepted and, thus, a single signal is sent to the signal processing unit, which in turn produces an output. Furthermore, the number of sensing elements 20 corresponds exactly to the number of keys on the holographic image of the keyboard, i.e., no two keys are linked to the same element and the converse is also true, i.e., no two elements are linked to a single key.

In another embodiment, the unit 10 may also have a central processing unit and an output unit, wherein an output unit may be a holographic monitor. The holographic monitor may be produced by a separate hologram producing unit that is embodied in the unit 10. Furthermore, the sensor elements 20 may be conventionally known photodiodes capable of detecting changes in light pattern supplied to them, i.e., these photodiodes are capable of reception of ambient light, which is conventionally well known to one skilled in the art of photodiodes. In a particular embodiment, the sensor elements 20 may be ambient light sensors manufactured by either Hamamatsu Corporation, 360 Foothill Road, Box 6910, Bridgewater, N.J. 08807-0910. Yet, in another embodiment the sensor elements 20 may be ambient light sensors manufactured by Advanced Photonix, Inc., 1240 Avenido Acaso, Camarillo, Calif. 93012.

Finally, the unit 10 may be fabricated so that it has a relatively small size capable. In this particular embodiment, the size of unit 10 does not exceed one and a half inches in length, width and height.

In the foregoing description, references to drawings and specific terms are used for descriptive purposes only and not to be construed as limiting the present invention to such. It is understood by one skilled in the art that the present invention is limited only to the prior art referenced above and the claims appended therein. The use of the drawings and specific terms is for the purposes of presentation, illustration and general comprehension only. Moreover, the drawings and the specific terms used are intended to be broadly construed and in no way limit the present invention.

It is, also, understood by one skilled in the art that other embodiments are possible as long as they are a reasonable interpretation of the appended claims and the disclosure above. Any and all changes or modifications to the present invention are feasible as long as they are within the scope and spirit of the appended claims.

What is claimed:

1. A portable visual sensing means comprising
an array, wherein said array comprises of a plurality sensing means;
a hologram producing means, wherein said hologram producing means is capable of projecting a flat holographic image of a computer keyboard;
a signal processing means;
wherein said array is connected to said signal processing means and said hologram producing means is connected to said signal processing means.

2. The visual sensing means of claim 1, wherein said flat holographic image of a computer keyboard further comprises a plurality of squares, wherein each square in said plurality of squares corresponds to a single sensing element in said plurality of sensing elements in said array.

3. The visual sensing means of claim 1, wherein said sensing means are ambient light photodiodes.

4. The visual sensing means of claim 1, wherein said sensing means are activated upon interception of a light path of said sensing element means that is directed toward a key on said flat holographic image of a computer keyboard.

5. The visual sensing means of claim 4, wherein said interception occurs when a user places a finger on said key of said flat holographic image of a computer keyboard

6. The visual sensing means of claim 1, wherein said sensing element means are positioned at respective angles so as to correspond to positions of said keys on said flat holographic image of a computer keyboard.

7. The visual sensing means of claim 6, wherein each of said sensing element means corresponds to exactly one said key on said flat holographic image of a computer keyboard.

8. The visual sensing means of claim 1, wherein upon interception of a light path of said sensing element means said sensing element means send a signal to said signal processing means.

9. The visual sensing means of claim 1, wherein said signal processing means is connected to an output means.

10. A portable visual sensing means comprising
an array, wherein said array comprises of a plurality sensing means, wherein said sensing elements are positioned at certain angles with respects to each other;
a hologram producing means, wherein said hologram producing means is capable of projecting a flat holographic image of a computer keyboard, wherein said image further comprises a mapping of virtual computer keyboard keys;
a signal processing means;
wherein said array is connected to said signal processing means and said hologram producing means is connected to said signal processing means; and,
wherein each said sensing element means corresponds to said virtual computer keyboard key on said flat holographic image of a computer keyboard.

11. The visual sensing means of claim 10, wherein said sensing element means are activated upon interception of a light path that links said sensing element means with said virtual computer keyboard key on said flat holographic image of a computer keyboard.

12. The visual sensing means of claim 11, wherein said interception occurs when a user places a finger on said virtual computer keyboard key on said flat holographic image of a computer keyboard.

13. The visual sensing means of claim 10, wherein said sensing element means are ambient light photodiodes.

14. The visual sensing means of claim 10, wherein each of said sensing element means correspond of a single said virtual computer keyboard key on said flat holographic image of a computer keyboard.
